(19) United States
(12) Patent Application Publication
(10) Pub. No.: US 2009/0233152 A1
(43) Pub. Date: Sep. 17, 2009

(54) FUEL CELL SYSTEM AND APPARATUS FOR SUPPLYING MEDIA TO A FUEL CELL ARRANGEMENT

(75) Inventors: Michael Rozumek, Neubrandenburg (DE); Marco Muehlner, Raduhn (DE)

Correspondence Address: DICKINSON WRIGHT PLLC, 1875 Eye Street, NW, Suite 1200, WASHINGTON, DC, 20006, US

(73) Assignee: ENERDAY GMBH, Stockdorf (DE)

(21) Appl. No.: 12/306,344

(22) PCT Filed: May 23, 2007
(86) PCT No.: PCT/DE07/00929

§ 371 Date: Mar. 3, 2009

(30) Foreign Application Priority Data
Jul. 10, 2006 (DE) 10 2006 031 863.3

(51) Int. Cl. H01M 2/02

(52) U.S. Cl. 429/34

(57) ABSTRACT

The invention relates to an apparatus (12 to 26) for supplying media to a fuel cell arrangement (28) in a fuel cell system (10), which apparatus at least partly consists of a chromium-containing metal alloy. According to the invention a surface (30) of the apparatus coming into contact with supply media is at least partly coated with a metal oxide ceramics (32).

The invention relates to an apparatus for supplying media to a fuel cell arrangement in a fuel cell system at least partly consisting of a chromium-containing metal alloy.

The invention further relates to a fuel cell system comprising such an apparatus.

Fuel cell systems serve to generate electric power from hydrogen and oxygen. Particularly in the field of mobile applications, for example in motor vehicles, the hydrogen is gained by the so-called reforming of fuel, i.e. particularly gasoline or diesel fuel. In stationary applications, i.e. particularly in the domestic field, particularly heating oil and natural gas qualify as raw materials for the generation of hydrogen. The heat generated during the at least partly exothermal reactions for reforming fuel may be used for heating purposes. In case of the deployment of high temperature fuel cells, so-called SOFC fuel cells (“Solid Oxide Fuel Cells”), the waste heat of the fuel cell stack may also be used for heating purposes and, like the waste heat of other components, be included in the temperature management of the entire fuel cell system.

Fuel cell systems comprising high temperature fuel cells are, depending on the their construction, operated in a temperature range between approximately 650° C. and 1000° C. Taking the heat development of additional secondary assemblies disposed spatially close to the actual fuel cell arrangement into account local temperatures of up to approximately 1250° C. may result. According to experience the regions having the highest temperature are to be found in the vicinity of the reformer arranged upstream with respect to the media supply of the fuel cell arrangement as well as in the vicinity of burners, for example an afterburner for the further conversion of the anode waste gas discharged by the fuel cell arrangement.

Conventionally the components strained by the high temperatures are manufactured from heatproof or highly heatproof chromium steels or chromium-containing nickel base alloys, it also being known that high-quality oxide dispersion stabilised metals known as powder metallurgically produced sintered components are used. The most of the time highly chromium-containing steels or alloys preferably containing, aside from other elements, aluminium and silicon as secondary alloy elements form thin and thick layers of the oxides of the respective alloy components at high temperatures, whereby the surfaces of the core material are protected from a further oxidation (from scaling) by a passivation layer.

The components configured in this or a similar manner can be frequently found in the field of the media supply to a fuel cell arrangement. The term media supply is, in this context, to be understood in its most general sense; it is therefore not limited to the primarily supplied substances such as, for example, diesel fuel and air, but in particular also relates to all other components carrying such substances which are supplied to the fuel cell arrangement themselves or after their chemical conversion. Thus, for example, the reformer, in case of a waste gas recirculation the afterburner and the piping of the system are to be taken into account in the considerations resulting in the present invention.

The use of chromium-containing materials is, under the common operational conditions, accompanied by the formation of volatile chromium compounds which may then, in the gas phase, carried on through the system on the downstream side. The formation of such chromium compounds, mainly of CrO₃ and CrO₂ (OH)₂, is promoted by the high temperatures and the water content of the atmosphere. Further problems may arise due to the formation of nitrides, particularly in connection with materials on the basis of nickel alloys.

To overcome these problems the affected assemblies may first be joined and then subjected to a heat treatment for the purpose of forming a thin and dense passivation layer.

However, the described problems are only insufficiently solved by these measures, and it is even possible that additional problems arise. Due to the thermal cycles generated, in particular, by turning the fuel cell system on and off, a chipping (“spalling”) of parts of the oxide layer may occur, particularly due to the different heat expansion coefficients and the accompanying tensions between the core material and the oxide layer. Such phenomena also need to be taken into consideration in the service life configuration of the components, for example by selecting a larger wall thickness to increase the chromium reservoir of the core material. The additional problems therefore particularly reside in a contamination of the system by the mentioned spalling as well as in an increase of weight due to the selection of a larger wall thickness. Due to the vaporisation of chromium and the spalling of the coating the core material will finally be depleted of chromium until a break-through oxidation will occur and the material will fail.

Other problems of the conventional systems relate to the functionality of the fuel cell arrangement. SOFC fuel cells and catalysts in the reformer may be poisoned and permanently damaged by the evaporating chromium compounds and their local accumulation. Said deterioration occurs particularly in the cathode area of the fuel cell arrangement since chromium is integrated in the cathode material (for example LaSrMnO₃). This is accompanied by an intolerable increase of the polarisation losses whereby the yield of electric power is decreased. Aside from the poisoning of the fuel cell arrangement a narrowing of pipe cross sections due to the deposition of the evaporated compounds can also be observed.

In the DE 44 22 624 A1 it is already suggested to provide bipolar plates for high temperature fuel cells with a protective layer of an oxidic chromate whereby it becomes possible to use chromium-containing alloys for the production of such bipolar plates.

In the DE 10 2004 002 365 A1 a coating of materials used in a fuel cell system with metals by means of gas diffusion after a heat treatment is suggested, the deposition of aluminium being preferred for reducing the chromium evaporation within the framework of SOFC fuel cell systems.

The invention is based on the object to enable a cost-effective production of apparatuses for supplying media to a fuel cell arrangement, wherein particularly the use of expensive steel alloys exhibiting low chromium evaporation rates is to be made obsolete.

This object is solved by the features of the independent claim.

Advantageous embodiments of the invention are disclosed in the dependent claims.

The invention is based on the generic apparatus in that a surface of the apparatus contacting supply media is at least partly coated with metal oxide ceramics. With the utilisation of the coating of surfaces per se known in connection with the design of bipolar plates for the apparatuses for supplying media as well a cost-effective measure is available for preventing the evaporation of volatile chromium compounds from the apparatuses. Due to the increased service life the material thickness may be reduced which leads to a reduction of the material deployment and a reduction in weight which is particularly advantageous in a mobile utilisation. Due to the reduction of the chromium evaporation rate the active components of the fuel cell system are protected, i.e. particularly the catalyst of the reformer and the cathodes of the fuel cell stack. Correspondingly the service life of these components is prolonged and the functionality of the entire system is enhanced.

Usefully it is contemplated that the metal oxide ceramics comprise a plurality of metal components. The different metal components comprise, for example, chromium and rare earth elements, for example lanthanum.

In a preferred embodiment it is contemplated that the metal oxide ceramics have a perovskite structure. Here, for example, LaCrO₃ doped with calcium or strontium is feasible.

It may also be contemplated that the metal oxide ceramics have a spinel structure. Such spinel structures are, for example, formed using chromium and manganese.

Usefully the metal oxide ceramics should contain chromium oxide.

The apparatus according to the invention is producible in a particularly advantageous manner in that the metal oxide ceramics are applied by means of gas phase deposition. CVD or PVD methods are feasible which are capable of providing highly reproducible layer systems.

It may also be contemplated that the metal oxide ceramics are applied by means of a slip method. The coating may take place by an immersing method or by wet powder spraying.

It may further be contemplated that the metal oxide ceramics are applied by a spraying method. Such spraying methods comprise, for example, thermal spraying or plasma spraying, these methods being particularly advantageous since no thermal outplacement treatment is required for stabilising the protective layer while in the mentioned slip methods a weld penetration is to be provided.

According to particularly preferred embodiments of the present invention it is contemplated that the metal oxide ceramics have a thickness from 1 ∥m to 25 μm. Small layer thicknesses of approximately 1 μm may be sufficient to achieve the success of the invention. An enlargement of the layer thickness may, depending on the method, simplify the manufacturing process since higher tolerances are permissible.

The invention further relates to a fuel cell system comprising an apparatus according to the invention.

The present invention will now be explained by way of example on the basis of preferred embodiments with reference to the accompanying drawings in which:

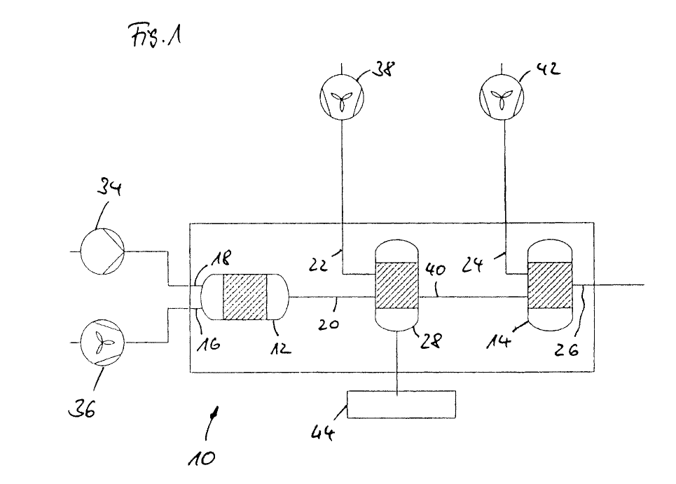

FIG. 1 is a schematic illustration of a typical fuel cell system; and

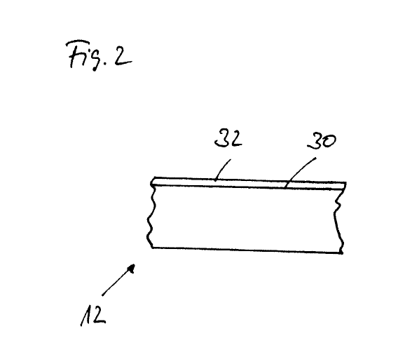

FIG. 2 shows a part of an apparatus according to the invention.

FIG. 1 shows a schematic illustration of a typical fuel cell system. FIG. 2 shows a part of an apparatus according to the invention. The fuel cell system 10 is supplied with fuel or air via a fuel supply 34 and an air supply 36. Air and fuel are supplied to a reformer 12 in which a hydrogen-rich reformate is generated via lines 16, 18. Said reformate is supplied to the anode side of a fuel cell stack 28 the cathode side of which is supplied with cathode air via another air supply 38 through a line 22 via a line 20. The anode waste gas flowing out of the fuel cell stack 28 via the line 40 is supplied to an afterburner 14 which is supplied with combustion air via another air supply 42 and a line 24. The waste gasses discharged from the afterburner 14 are discharged from the fuel cell system 10 via a line 26. The electric power generated in the fuel cell stack 28 is also taken from the fuel cell system 10 and, for example, supplied to a DC/DC-converter 44. All components inside of the fuel cell system 10 which are potentially subjected to high temperatures and carry substances supplied to the fuel cell stack 28 may be formed in the manner according to the invention, i.e. their surface 30 may be provided with a coating of metal oxide ceramics 32. This is illustrated by way of example in FIG. 2 with reference to a surface section of the reformer 12. Comparable finishings of the surfaces can be found in the supply lines 16, 18 to the reformer 12, the reformate line 20 and the cathode air supply line 22. In case of a partial waste gas recirculation from the afterburner 14 by means of which the waste gas is introduced into the flow path upstream of the fuel cell stack 28 usefully the anode waste gas line 40, the afterburner air supply line 24, the afterburner 14 and the waste gas line 26 may also be provided with the surface structure according to FIG. 2.

The features of the invention disclosed in the above description, in the drawings as well as in the claims may be important for the realisation of the invention individually or in any combination.

### LIST OF NUMERALS

10 fuel cell system
12 reformer
14 afterburner
16 air supply line
18 fuel supply line
20 reformate line
22 cathode air supply line
24 afterburner air supply line
26 waste gas line
28 fuel cell stack
30 surface
32 metal oxide ceramics
34 fuel supply
36 air supply
38 air supply
40 anode waste gas line
42 air supply
44 DC/DC-converter

1. An apparatus for supplying media to a fuel cell arrangement in a fuel cell system, said apparatus comprising: a chromium-containing metal alloy, having a surface of the apparatus contacting supply media at least partly coated with metal oxide ceramics.

2. The apparatus for supplying media of claim 1, wherein the metal oxide ceramics comprise a plurality of metal components.

3. The apparatus for supplying media of claim 1, wherein the metal oxide ceramics comprise a perovskite structure.

4. The apparatus for supplying media of claim 1, wherein the metal oxide ceramics comprise a spinel structure.

5. The apparatus for supplying media of claim 1, wherein the metal oxide ceramics contain chromium oxide.

6. The apparatus for supplying media of claim 1, wherein the metal oxide ceramics are applied by gas phase deposition.

7. The apparatus for supplying media of claim 1, wherein the metal oxide ceramics are applied by a slip method.

8. The apparatus for supplying media of claim 1, wherein the metal oxide ceramics are applied by a spraying method.

9. The apparatus for supplying media of claim 1, wherein the metal oxide ceramics have a thickness of 1 μm to 25 μm.

10. A fuel cell system comprising an apparatus of claim 1.
